(19) United States
(12) Patent Application Publication
(10) Pub. No.: US 2025/0276738 A1
(43) Pub. Date: Sep. 4, 2025

(54) Spaceframe for Commercial Vehicles

(71) Applicant: BSL CH AG, Chur (CH)

(72) Inventors: Noamaan Siddiqi, Mytchett (GB); Chetna Jain, Mytchett (GB)

(21) Appl. No.: 18/858,699

(22) PCT Filed: Apr. 19, 2023
(86) PCT No.: PCT/IB23/54002

§ 371 Date: Oct. 21, 2024

Related U.S. Application Data
(60) Provisional application No. 63/333,067, filed on Apr. 20, 2022.

(51) Int. Cl. B62D 23/00; B62D 31/02; B62D 33/04; B62D 33/06

(52) U.S. Cl. CPC B62D 23/005; B62D 31/02; B62D 33/044; B62D 33/0617

(57) ABSTRACT

A spaceframe for commercial vehicles is described. In embodiments, the spaceframe includes a body module and a cockpit module (incorporating a front module). In embodiments, the body module is divided into several modules such as a mid-module, a rear module, upper module, and a wheel arch module for modularity of the spaceframe.

### CROSS-REFERENCE TO RELATED APPLICATIONS

This application is a National Stage Entry of International Patent Application No. PCT/IB23/54002, which claims priority and benefit to U.S. Provisional Application No. 63/333,067, filed on Apr. 20, 2022, and titled Spaceframe for Commercial Vehicles, the contents of which are incorporated herein by this reference as though set forth in their entirety.

### FIELD OF USE

The present invention relates to an innovative spaceframe structure for commercial vehicles, which is lighter in weight and easier to construct than a standard ladder frame. BACKGROUND

Medium and heavy-duty commercial vehicles are conventionally built on a so-called ladder frame arrangement, whereby two main longitudinal beams, or spars, sometimes made up of a single piece but often made up of multiple pieces (“beams”), typically manufactured of steel, are assembled in such a manner with shorter transverse beams, spars, or beams are welded, bolted, or otherwise attached perpendicularly in-between the two main longitudinal beams. This “ladder” arrangement is the primary structure, which is then used to attach additional components, either directly through various fixing methods including welding, bolting, or riveting, or indirectly through brackets and the like. All elements of the vehicle are directly or indirectly attached to this ladder including, but not limited to, axles incorporating suspension elements, propulsion systems whether they are electric or internal combustion, transmission components such as transaxles/differentials and gearboxes, payload compartments and bays (including boxes, flatbeds, “curtainsider” and the like), floors (including low floors and roller beds), and the driver's cabin structure (“cab”).

The torsional rigidity of a ladder frame is substantially lower than other types of structures, especially in vertical loads or bumps, which results in poor handling due to increased height. The ladder chassis structure is strong in certain load-cases but is subject to flex/twist when sideways forces are applied during cornering or uneven road surface. The ladder chassis limits accommodation of different vehicle platforms and is hence less modular in nature. Ladder chassis require a structural floor to be built to carry any payload, and due to the torsional loading, separate structures for the driver (a cab) and for payloads (typically a box) must be created, which results in a substantive weight penalty.

It is therefore an objective of the present invention to provide a superior alternative to the ladder frame, an alternative that is lighter in weight and easier to construct, namely a spaceframe. Spaceframe structures are utilized in a number of different fields, including in aircraft and industrial structures. There are no spaceframe chassis for lighter to medium duty vehicles, such as commercial delivery trucks.

### SUMMARY OF THE DISCLOSURE

The present disclosure relates to a spaceframe structure for commercial vehicles which is light in weight and simple in construction. In embodiments, a spaceframe is disclosed that comprises a cage-like structure and truss (multi-interconnecting beams which can then be regarded as “three-dimensional”) that provides strength and support for multi-directional forces. A spaceframe usually distributes its weight evenly in all directions and is strong but lightweight compared to a similar-sized self-supporting structure, which improves performance in a vehicle.

The present disclosure also relates to a spaceframe structure that provides modularity in design. In embodiments, a modular spaceframe design allows sections of the spaceframe to be useful for different vehicle platforms. Modular sections of the spaceframe are able to be used in several vehicle platforms with minimal changes, for example different vehicle applications (e.g., right-hand-drive vehicle, left-hand-drive vehicle, vehicles with different chassis length and wheelbases, variations of vehicle powertrain, etc.). Spaceframes disclosed herein also facilitate four-corner independent suspension and flexibility for wheelbase and wheel track.

In embodiments, a spaceframe construction comprises an integral cockpit (cabin) area for the driver(s) with a relatively lower seating position. In embodiments, the spaceframe comprises a full-width windscreen in the integral cockpit, which provides better visibility to the driver. In embodiments, the spaceframe comprises an integral payload compartment with an upper platform of the lower spaceframe structure forming the basis for a voluminous payload compartment floor.

Spaceframes constructed according to the present disclosure may comprise a number of steel beams, arranged longitudinally, transversally, horizontally, and vertically, and attached together at a number of points (“nodes”) through mechanical fixings (such as rivets or bolts and nuts), welding, or some combination thereof.

In embodiments, composite or metallic body panels and subsystems are adhesively bonded, welded, or otherwise fixed to the outer features of the spaceframe. For example, a platform structure in the form of a payload bay floor may be adhesively bonded, welded or otherwise fixed to the bulkhead structure. Independent suspension elements may also be bolted or otherwise fixed to the platform structure. Propulsive, energy storage, and generation equipment may also be bolted or otherwise fixed, either directly or indirectly (via brackets), to the platform structure.

In embodiments, the spaceframe comprises a number of steel beams, in the form of a closed-channel (such as a D-channel, O-channel, or square channel), arranged longitudinally, transversally, horizontally, and vertically, and attached together at a number of points (“nodes”) through mechanical fixings (such as rivets or bolts and nuts), welding, or some combination thereof.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1 is a perspective view of an embodiment of a modular spaceframe for commercial vehicle application.

FIG. 2 is a perspective view of a body module as a part of FIG. 1.

FIG. 3 and FIG. 4 are perspective views of a mid-module of the body module as a part of FIG. 2.

FIG. 5 and FIG. 6 are perspective views of a rear module of the body module as a part of FIG. 2.

FIG. 7 is a perspective view of an upper module of the body module as a part of FIG. 2.

FIG. 8 is a perspective view of a wheel arch module of the body module as a part of FIG. 2.

FIG. 9 is a perspective view of a cockpit module incorporating a front module as a part of FIG. 1.

FIG. 10 is a perspective horizontal sectional view of a front module as a part of FIG. 9.

FIG. 11 is a perspective view of an embodiment of a commercial delivery truck constructed with an embodiment of a spaceframe according to the present disclosure.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

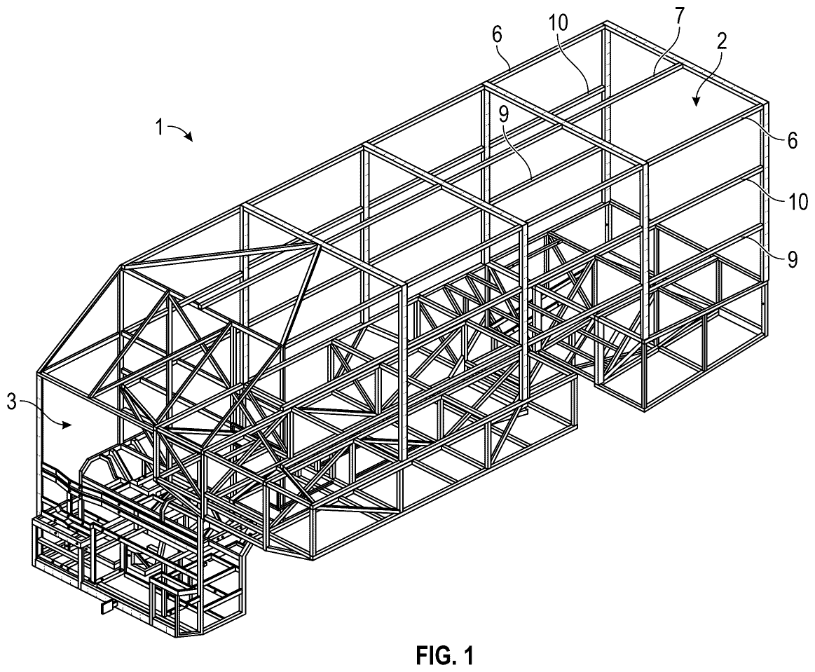

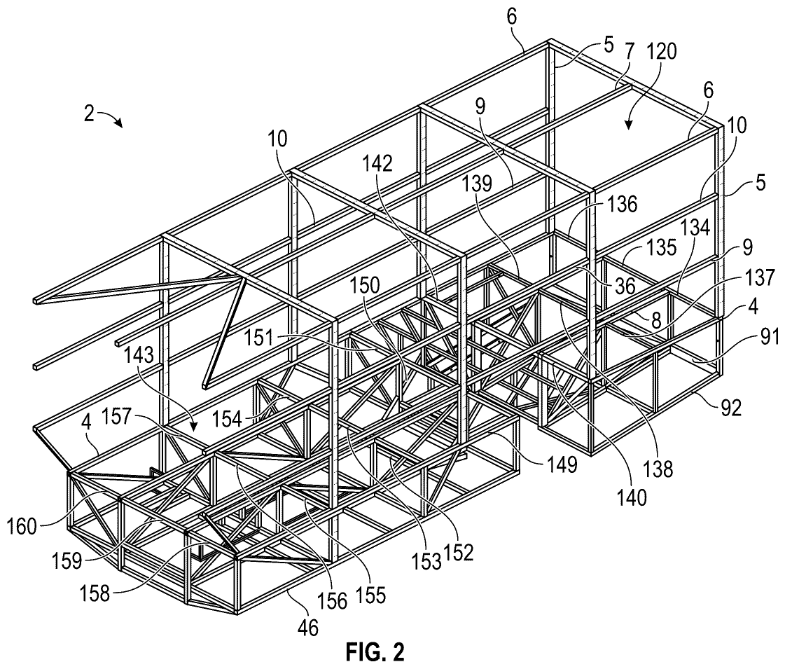

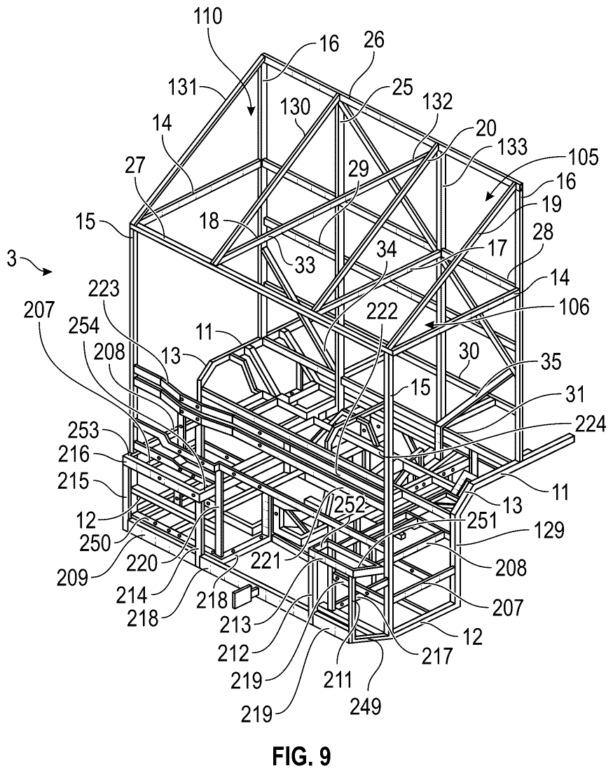

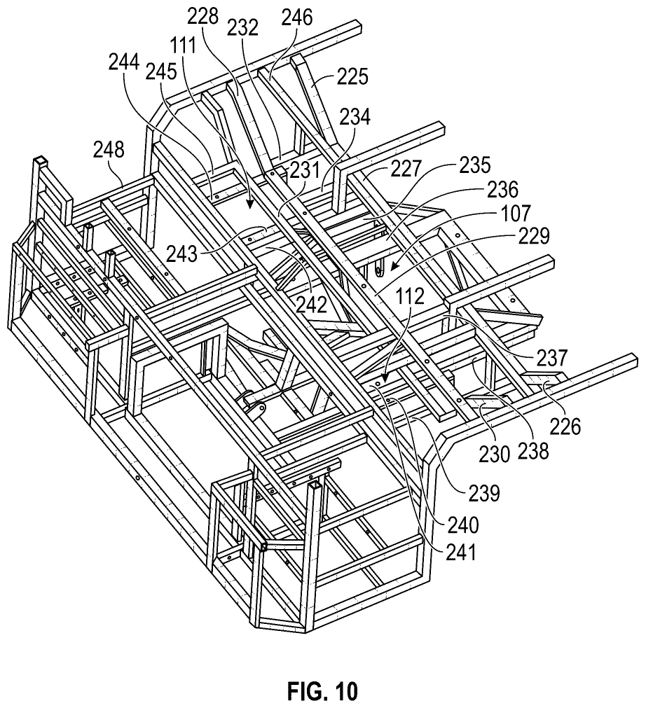

The present disclosure includes embodiments of a spaceframe for a commercial vehicle FIG. 1 which is light in weight, simple and modular in construction, and includes a body module FIG. 2 and a cockpit module (incorporating a front module) FIG. 9 and FIG. 10. In embodiments, the body module 2 comprises a plurality of laterally spaced, longitudinally extending side beams, and a plurality of upright beams each being connected to a respective side beam. The body module may also include a plurality of upper transverse metallic beams, each being connected to plurality of upper longitudinal beams. The plurality of laterally spaced, longitudinally extending side beams connected to the rear pillar-forming section and B-pillar forming section defines longitudinal length between the rearward pillars and the B-pillars. The plurality of side beams, the plurality of upper longitudinal beams and the pair of rear pillars in embodiments of the body module are secured by interfacing with a plurality of connecting beams at a number of junctions or nodes. The upright beams at the rear pillar form the top of the rear portal 120 to which payload compartment egress equipment (e.g., barn doors or roller shutter doors or similar) are fixed. Other aspects of the present disclosure also provide modularity in the spaceframe structure. For example, the body module 2 can be subdivided into several modules such as a mid-section module 21, rear module 22, upper module 23, and wheel arch module 24.

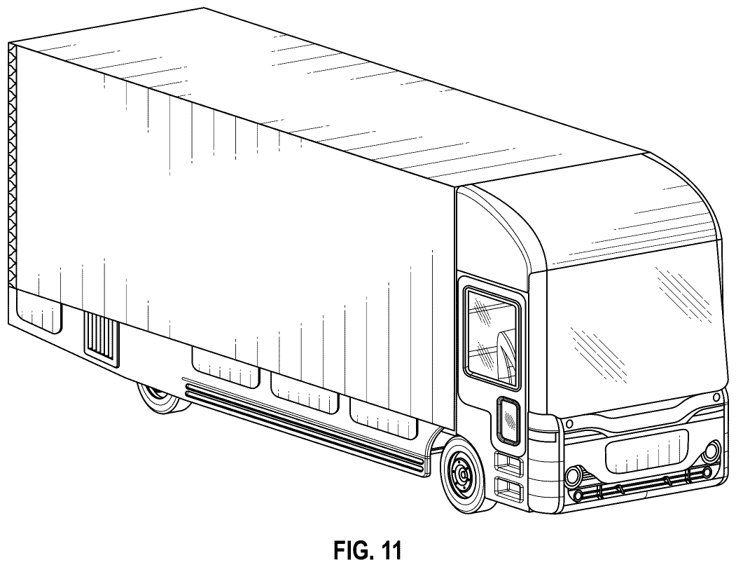

FIGS. 1 shows an exemplary embodiment of a modular spaceframe for commercial vehicle applications. For example, FIG. 11 shows a perspective view of an embodiment of a commercial delivery truck constructed with an embodiment of a spaceframe according to the present disclosure. The spaceframe 1 includes a body module 2 and a cockpit module incorporating a front module 3. As shown in FIG. 2, an embodiment of the body module 2 comprises a pair of laterally spaced, longitudinally extending side beams 4 to B-pillar forming section and pair of upright beams 5, each being connected with welding or by other appropriate means to a respective side beam and extending upwardly to form a pair of rear pillars 5. The body module 2 also includes a plurality of upper longitudinal beams 6, each including a B-pillar forming portion and a longitudinally extending portion.

In embodiments, each rear pillar-forming section is connected with welding or other appropriate method to respective side beams 4, 6. Each rear pillar-forming section then extends upwardly from its respective side beam 4, 6 to form a rear pillar 5, and each longitudinally extending portion from rear pillar to B-pillar forming section and hence defining longitudinal length 4, 6 between the rearward pillars and the B-pillars.

In embodiments, the side beams 4, the upper longitudinal beams 6, and the plurality of pillars 5 in the body module 2 are secured by connecting a plurality of beams connected at nodes through welding or by other appropriate means. The upright beams at the rear pillar 5 form the top of the rear portal 120 to which payload compartment egress equipment (e.g., barn doors or roller shutter doors) are fixed.

FIG. 2 shows an embodiment of a body module 2 which is further subdivided into multiple modules including the mid-module 21, rear module 22, upper module 23, and wheel arch module 24 enabling modularity of the spaceframe 1.

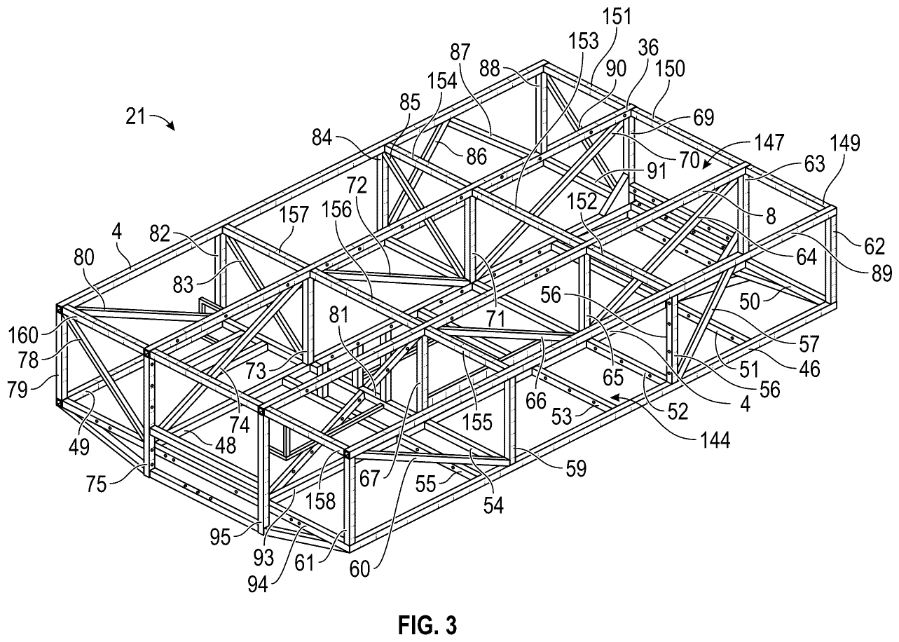

FIG. 3 shows a perspective view of an embodiment of a mid-module as viewed from the upper side of the mid-module. The mid-module 21 of the body module 2 comprises upper transverse beams 149, 150, 151, 152, 153, 154, 155, 156, 157, 158, 159, 160 appropriately connected with welding or other appropriate means with upper longitudinally extending beams 4, 8,36.

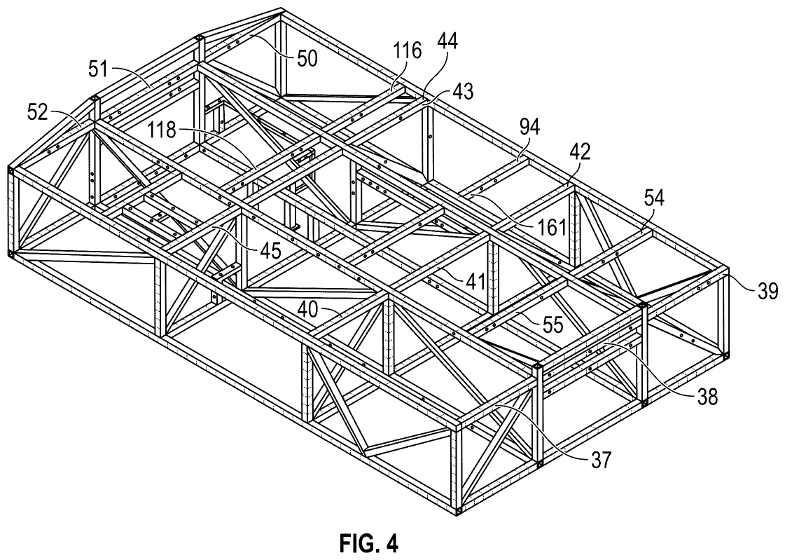

FIG. 4 shows a perspective view of an embodiment of a mid-module as viewed from the lower side of mid-module. Mid-module 21 of the body module 2 comprises lower transverse beams 37, 38, 39, 40, 41, 42, 43, 44, 45, 50, 51, 52, 94, 161, 116, 118 appropriately connected with welding or by other appropriate means, with lower longitudinally extending beams 46, 48, 49, 93.

In embodiments, the upper mid-module 147 and lower mid-module 144 of the body module 2 are connected by a plurality of vertical beams 62, 63, 69, 88, 56, 65, 71, 84, 82, 73, 67, 59, 61, 95, 75, 79 and a plurality of vertically angular beams 50, 89, 64, 90, 57, 66, 70, 72, 86, 87, 85, 92, 66, 83, 74, 60, 80, 78, 81 appropriately connected with welding or by other appropriate means which support and strengthen the mid-module 21 of the body module 2.

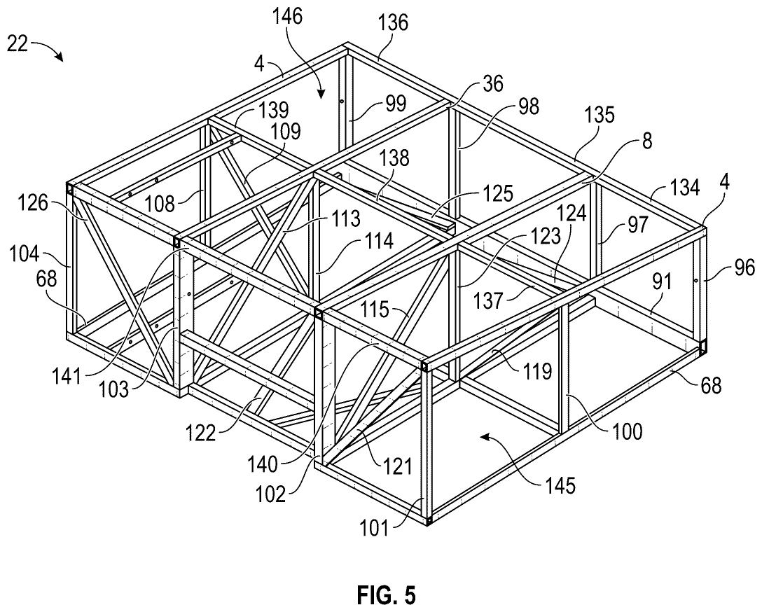

FIG. 5 shows a perspective view of an embodiment of a rear module of the body module 2 as viewed from the upper side of the of the rear module 22 of the body module 2. Rear module 22 of the body module 2 comprises upper transverse beams 134, 135, 136, 137, 138, 139, 140, 141, 142 appropriately connected with welding, or by other appropriate means, with upper longitudinally extending beams 4, 8, 36.

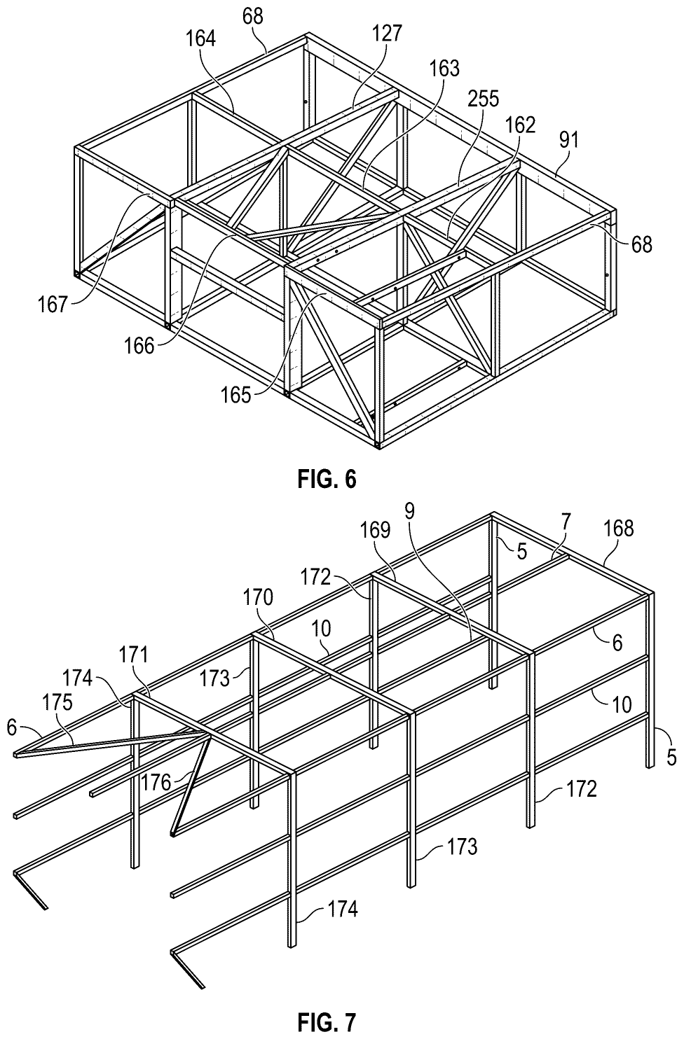

FIG. 6 shows a perspective view of an embodiment of a rear module 22 as viewed from lower side of the of the rear module. Rear module 22 of the body module 2 comprises lower transverse beams 91, 162, 163, 164, 165, 166, 167 appropriately connected with welding or by other appropriate means with lower longitudinally extending beams 68,127, 255.

The upper rear module 146 of the body module 2 and lower rear module 145 of the body module 2 are appropriately connected with welding or by other appropriate means using plurality of vertical beams 96, 97, 98, 99, 100, 123, 114, 108, 101, 102, 103, 104 and vertically angular beams 124, 119, 115, 109, 113, 126 which support and strengthen the rear module 22 of the body module 2.

FIG. 7 shows a perspective view of an embodiment of a top module of the body module 2. The top module 23 body module 2 comprises a pair of longitudinally extending beams 6, 7, 9, 10, transverse beams 168, 169, 170, 171 and pair of vertical beams 5, 172, 173, 174 appropriately connected with welding or by other appropriate means which support and strengthen the upper module 23 of the body module 2.

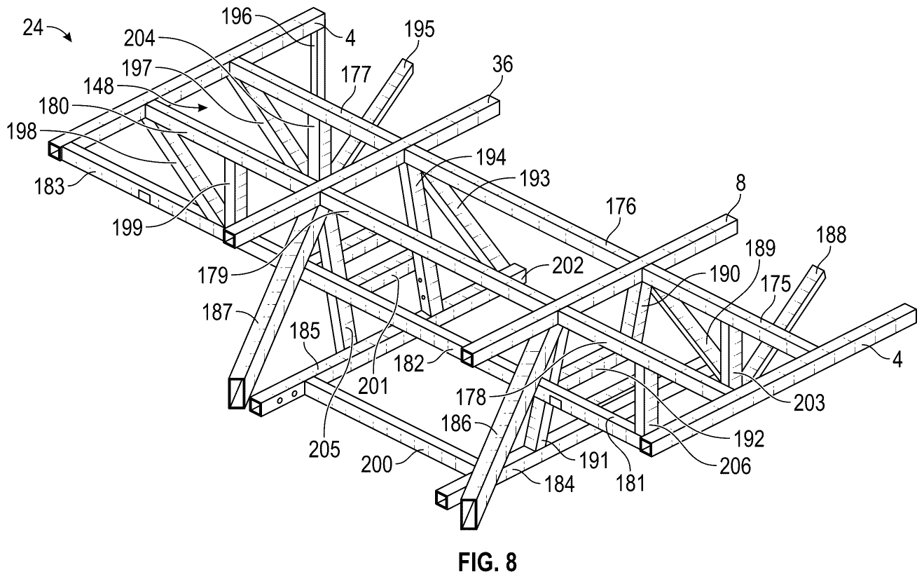

FIG. 8 shows a perspective view of an embodiment of a wheel arch module of the body module 2. Wheel arch module 24 of the body module 2 comprises longitudinally extending beams 4, 8, 36, 184, 185, transverse beams 175, 176, 177, 178, 179, 180, 181, 182, 183, 200, 202 vertical beams 199, 206, 203, 196 and vertically angular beams 186, 187, 191, 190, 205, 194, 198, 197, 195, 193, 192, 188 appropriately connected with welding or by other appropriate means which support and strengthen the wheel arch liner module 24 of the body module 2.

In embodiment, four modules of a spaceframe (mid-module 21, rear module 22, top module 23, and wheel arch liner module 24) are appropriately rigidly interconnected to each other with welding or by other appropriate means to form the body module 2.

In embodiment, the body module comprises a plurality of laterally spaced, longitudinally extending side beams to B-pillar forming section and plurality of upright beams, each being connected to a respective side beam and extending upwardly to form a pair of rear pillars. The body module also includes a pair of upper longitudinal steel beams and each including a B-pillar forming portion and a longitudinally extending portion. Each rear pillar-forming section is connected to a respective side beam and extends upwardly therefrom to form a rear pillar, and each longitudinally extending portion from rear pillar to B-pillar forming section and hence defining longitudinal length between the rearward pillars and the B-pillars. The side beams, the upper longitudinal beams, and the pair of pillars in the body module is secured by constructing a plurality of connecting beams. The upright beams at the rear pillar form the top of the rear portal to which payload compartment egress equipment (e.g., barn doors or roller shutter doors) are fixed.

In embodiments, a plurality of longitudinal beams of upper sections 146, 147, 148 and plurality of longitudinal beams of lower sections of mid-module 21, rear module 22 and wheel arch module 24 form the upper 143 and lower 144, 145 sections of a platform structure, which are connected by a plurality of transverse beams and vertical beams. A gap between the upper 143 and lower sections 144, 145 of the platform structure may be such as to render the upper section 143 of the platform structure to be at the same height as typical trailer docks.

FIG. 9 shows a perspective view of an embodiment of a cockpit module (incorporating the front module). The cockpit module embodiment (incorporating the front module) 3 comprises a plurality of front lower side beams 11, 12, 13, a pair of front upper side beams 14 and a plurality of upright beams forming an A-pillar 15 to which a windscreen or other protective aerodynamic device is directly fixed, via bonding adhesive or other fixing method, and a B-pillar 16. A horizontal transverse beam 26, 27 at the top of the A-pillar forms a forward portal structure 106. Above the forward portal 106 beams are installed longitudinally 14, 17, 18 and vertically at an angle 19, 20, 130, 131, 132 such as to provide structure for an aerodynamic fairing to be fixed (the frontal acrodynamic structure 110). A plurality of horizontal beams 7, 9, 10 connect the rear portal 120 to the rear of the frontal acrodynamic structure 110. A plurality of upright beams 16, 133, 25 arise from immediately behind the cockpit structure to the top of the aerodynamic structure 110 to form a bulkhead structure 105. A plurality of horizontal transverse beams 26, 28, 29, 30, 31 and diagonal beams 32, 33, 34, 35 orthogonal to each other are attached within the bulkhead structure 105. A plurality of laterally placed vertical beams 15, 16, 129, a plurality of laterally placed longitudinal beams 14, 12, 11, 207, 208 and laterally placed vertically angular beams 13 are appropriately rigidly interconnected with welding or by other appropriate means to form support structure for the cabin door. The plurality of vertical beams 15, 215, 214, 220, 212, 219, 211, the plurality of transverse beams 27, 221, 224, 223, 222, 216, 213, 209, 128, 210, the plurality of longitudinal beams 12, 207, 208, 217, 218, and vertically horizontally angular beams 249, 250, 252, 251, 253, 254 are appropriately rigidly interconnected with welding or by other appropriate means to form a strong crash safety support structure and hence improve crash safety performance of the commercial vehicle across all aspects.

FIG. 10 shows a perspective horizontal sectional view of an embodiment of a cockpit module. The plurality of the vertical, transverse, longitudinal, and vertically angular beams 246, 225, 228, 231, 234, 227, 235, 236, 229, 237, 238, 230, 226, 239, 240, 241, 242, 243, 248, 244, 247, 245, 232 are appropriately rigidly interconnected by means of welding or by other appropriate means, to form the cockpit floor structure 107, driver's seat mounting structure 111 and co-driver's scat mounting structure 112.

In embodiment, the cockpit module (incorporating the front module) 3 front module is rigidly fixed to the body module by means of fixing via welding to interconnecting nodes or junctions, connecting each beam of the cockpit module front module with a respective side beam of the body module.

With embodiments of the cockpit module, the spaceframe facilitates construction of an integral cockpit area for the drives with a relatively lower seating position, a full-width windscreen, and an integral payload compartment with the upper platform 143 of the lower spaceframe structure forming the basis for the payload compartment floor.

In embodiments, the cockpit module (incorporating the front module) 3 comprises a plurality of vertical, transverse, and angular beams to form a structure for windscreen, forward portal 106, crash safety support structure, bulkhead structure 105, cockpit floor structure 107, driver's seat mounting structure 111, co-driver's seat mounting structure 112, or other protective aerodynamic device 110, fixing via bonding adhesive or other fixing method.

In embodiments, a cockpit module (incorporating front module) comprises a pair of front lower side beams, a pair of front upper side beams and transverse beams, and two pairs of upright beams forming an A-pillar to which a windscreen or other protective aerodynamic device is directly fixed, via bonding adhesive or other fixing method, and a B-pillar. A horizontal transverse beam at the top of the A-pillar forms the forward portal structure. Above the forward portal, beams are installed longitudinally and vertically at an angle such as to provide structure for an aerodynamic fairing to be fixed (the aerodynamic structure). A plurality of horizontal beams connects the rear portal to the rear of the frontal aerodynamic structure. A plurality of upright beams arises from immediately behind the cockpit structure to the top of the aerodynamic structure to form a bulkhead structure. A plurality of horizontal transverse beams and diagonal beams orthogonal to each other are attached within the bulkhead structure.

In embodiment, a cockpit module (incorporating front module) is rigidly fixed to the mid- and upper modules by rigidly interconnecting each beam of cockpit module (incorporating front module) with the respective beams of the mid-and upper modules.

In embodiments, the cockpit module, and the spaceframe in general, forms crash support safety structures with a plurality of vertical beams, plurality of transverse beams, plurality of longitudinal beams and vertically horizontally angular beams that are rigidly appropriately interconnected with welding or by other appropriate means.

What is claimed is:

1. A spaceframe for a commercial vehicle, comprising a body module and a cockpit module, the body module comprising a modular frame comprising a mid-module, a rear module, an upper module and a wheel arch module.

2. The spaceframe of claim 1, further comprising a plurality of longitudinal beams forming upper and lower sections of a platform structure, wherein the plurality of longitudinal beams are connected by a plurality of transverse beams and vertical beams.

3. The spaceframe of claim 1, wherein the cockpit module comprises a pair of front lower side beams, a pair of front upper side beams and transverse beams, two pairs of upright beams forming an A-pillar configured to have a windscreen or other protective aerodynamic device affixed thereto via bonding adhesive or other fixing method, and a B-pillar.

4. The spaceframe of claim 3, further comprising a horizontal transverse beam at the top of the A-pillar and B-pillar forming a forward portal structure.

5. The spaceframe of claim 4, wherein above the forward portal structure, beams are installed longitudinally and vertically at an angle such as to provide structure for a frontal aerodynamic structure to be fixed, wherein a plurality of horizontal beams connect a rear portal to a rear of the frontal aerodynamic structure.

6. The spaceframe of claim 5, wherein a bulkhead structure is formed from a plurality of upright beams behind the cockpit structure to the top of the aerodynamic structure, wherein a plurality of horizontal transverse beams and diagonal beams orthogonal to each other are attached within the bulkhead structure.

7. The spaceframe of claim 3, wherein a plurality of the vertical, transverse, longitudinal, and vertically angular beams are rigidly interconnected with welding or by other appropriate means to form a cockpit floor structure and driver and co-driver seats mounting structure.

8. The spaceframe of claim 1, wherein the cockpit module comprises an integral cockpit area for the driver with a relatively lower seating position, a full-width windscreen, and an integral payload compartment with an upper platform of a lower spaceframe structure forming the basis for a payload compartment floor.
